(19) United States
(12) Patent Application Publication
(10) Pub. No.: US 2014/0370804 A1
(43) Pub. Date: Dec. 18, 2014

(54) NFC COMMUNICATIONS WITH MULTIPLE NFC ANTENNAS

(71) Applicant: Broadcom Corporation, Irvine, CA (US)

(72) Inventor: Philip Dorning, Swindon (GB)

(21) Appl. No.: 13/934,585

(22) Filed: Jul. 3, 2013

Related U.S. Application Data
(60) Provisional application No. 61/835,349, filed on Jun. 14, 2013.

(51) Int. Cl. H04B 5/00

(52) U.S. Cl. CPC H04B 5/0031
USPC 455/41.1

(57) ABSTRACT

Various configurations and arrangements of various communication devices and antenna solutions are disclosed. Antenna solutions disclosed herein include a near field communication (NFC) controller, and at least one antenna interface circuit, which together may control and effectuate NFC communications via at least two NFC antennas. The at least two NFC antennas may be connected together in series or in parallel, and may be magnetically isolated by an isolation element.

### TECHNICAL FIELD

The present disclosure relates generally to multiple antenna arrangements for implementing near field communications (NFC) within an NFC enabled communication device.

### BACKGROUND

Mobile wireless communication devices such as cellular telephones, two-way radios, personal digital assistants (PDAs), personal computers (PCs), tablet computers, laptop computers, home entertainment equipment, radio frequency (RF) identification (RFID) readers, RFID tags, etc. have evolved from large devices focused on a single application or use, such as analog voice communications, to comparatively smaller devices that are capable of and used for many different things such as digital voice communications and digital data communications, e.g., Short Message Service (SMS) for text messaging, email, packet switching for access to the Internet, gaming, Bluetooth®, Multimedia Messaging Service (MMS) and secure transaction capability to provide some examples. In addition to these capabilities, the mobile wireless communication devices of today have additional non-communication related capabilities, such as audio and/or video recording to provide an example, and software applications, such as a calendar and a phone book, to provide some examples.

Near Field Communication (NFC) is one technology being implemented in mobile devices for many present and anticipated applications. NFC can be accomplished by touching or placing two NFC enabled devices in close proximity to each other. NFC can be used for, among other things, contactless transactions, data exchange, and/or setup and mobile provisioning. For example, contactless payment systems can be configured to implement NFC for mobile payment by storing credit card and/or loyalty program information within a virtual wallet in an NFC enabled device which can be touched to or placed in close proximity with an NFC terminal that accepts the credit card and/or loyalty program information to complete the mobile payment transaction. NFC can also be used to bootstrap setup other wireless communication methods such as Bluetooth® and/or WiFi™ An NFC file transfer can be used to automatically complete the steps of enabling, pairing and establishing a Bluetooth® connection, such as for Bluetooth® speakers or headsets, etc. The same principle can be applied to the configuration of Wi-Fi™ networks. NFC data exchange can also be used in social networking situations for exchanging contact information, photos, videos, files, etc.

### BRIEF DESCRIPTION OF THE DRAWINGS

For a more complete understanding of example embodiments of the present disclosure, reference is now made to the following descriptions taken in connection with the accompanying drawings in which:

FIG. 1 illustrates a block diagram of a first exemplary NFC enabled communication device according to an exemplary embodiment of the present disclosure;

FIG. 2 further illustrates the block diagram of the first exemplary NFC enabled communication device according to an exemplary embodiment of the present disclosure;

FIG. 3 illustrates an exemplary front end module that can be implemented within the first exemplary NFC enabled communication device according to an exemplary embodiment of the present disclosure;

FIG. 4 illustrates an exemplary multiple antenna arrangement for implementing NFC in accordance with one embodiment of the present disclosure;

FIG. 5 illustrates an exemplary equivalent circuit for implementing an antenna interface circuit in accordance with various embodiments of the present disclosure;

FIG. 6 illustrates exemplary equivalent circuits for implementing antennas in accordance with various embodiments of the present disclosure;

FIG. 7 illustrates an exemplary multiple antenna arrangement for implementing NFC in accordance with another embodiment of the present disclosure;

FIG. 8 illustrates an exemplary multiple antenna arrangement for implementing NFC in accordance with another embodiment of the present disclosure;

FIG. 9 illustrates an exemplary multiple antenna arrangement for implementing NFC in accordance with another embodiment of the present disclosure;

FIG. 10 illustrates an exemplary multiple antenna arrangement for implementing NFC in accordance with another embodiment of the present disclosure; and

FIGS. 11A and 11B illustrate frontal and rear perspective views of an NFC enabled communication device in which a multiple antenna arrangement may be implemented in accordance with various embodiments.

### DETAILED DESCRIPTION OF THE DISCLOSURE

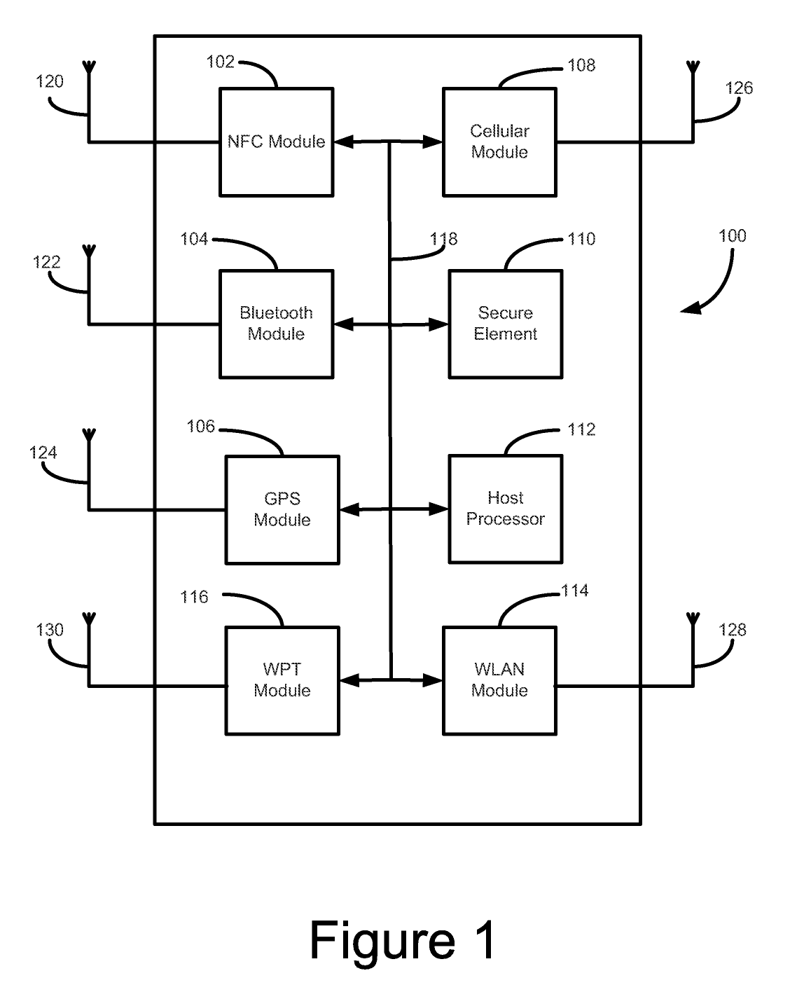

FIG. 1 illustrates a block diagram of one exemplary NFC enabled communication device according to an exemplary embodiment of the present disclosure. An NFC enabled communication device 100 may communicate information over wireless communication networks in accordance with various communication standards. The NFC enabled communication device 100 can represent a mobile communication device, such as a cellular phone or a smartphone, a mobile computing device, such as a tablet computer or a laptop computer, or any other electronic device that is capable of communicating information over communication networks that will be apparent to those skilled in the relevant art(s) without departing from the spirit and scope of the present disclosure.

The NFC enabled communication device 100 can include an NFC module 102, a Bluetooth® module 104, a Global Position System (GPS) module 106, a cellular module 108, a secure element 110, a host processor 112, a wireless local area network (WLAN) module 114, a Wireless Power Transfer (WPT) module 116, or any combination thereof which are communicatively coupled to one another via a communication interface 118. The NFC enabled communication device 100 can also include an NFC antenna 120, a Bluetooth® antenna 122, a GPS antenna 124, a cellular antenna 126, a WLAN antenna 128, and a WPT antenna 130. It should be noted that the NFC enabled communication device 100 need not include all of: the Bluetooth® module 104, the GPS module 106, the cellular module 108, the secure element 110, the host processor 112, the WLAN module 114, the WPT module 116, communication interface 118, the Bluetooth® antenna 122, the GPS antenna 124, the cellular antenna 126, the WLAN antenna 128, and/or the WPT antenna 130. Those skilled in the relevant art(s) will recognize that other configurations and arrangements of the NFC enabled communication device 100 are possible without departing from the spirit and scope of the present disclosure. Additionally, those skilled in the relevant art(s) will also recognize that the NFC module 102, the Bluetooth® module 104, the GPS module 106, the cellular module 108, the secure element 110, the host processor 112, the WLAN module 114, and/or the WPT module 116 need not necessarily be communicatively coupled to one another via the communication interface 118. In some situations, those modules that are communicatively coupled to the communication interface 118 can independently communicate with other communication enabled devices without internal communication.

The NFC module 102 can be configured to provide wireless communications between the NFC enabled communication device 100 and another NFC capable device in accordance with various NFC standards. The NFC module 102 can be configured to operate in an initiator or reader mode of operation to initiate communications with another NFC capable device, or in a target or tag mode of operation to receive communications from another NFC capable device. Additionally, the NFC module 102 may derive or harvest power from the electromagnetic field received from this other NFC capable device when operating in the field power harvesting mode. The power derived or harvested from the received field can sometimes be adequate to power the NFC module 102 and/or the secure element 110.

As explained in more detail below, the NFC module 102 can communicate with other NFC capable devices through the NFC antenna 120. The NFC antenna 120 can comprise multiple inductive coupling elements controlled by a switch and driven by a single NFC controller (NFCC). The multiple inductive coupling elements could be placed in different locations in the NFC enabled communication device 100 to increase the operating volume and provide extended field coverage for the NFC enabled communication device 100.

The Bluetooth® module 104 can be configured to provide wireless communications between the NFC enabled communication device 100 and another Bluetooth® capable device through the Bluetooth® antenna 122 in accordance with various Bluetooth® or Bluetooth® Low Energy (BLE) standards. The Bluetooth® module 104 can be configured to operate in a master mode of operation to initiate communications with another Bluetooth® capable device or in a slave mode of operation to receive communications from another Bluetooth® capable device.

The GPS module 106 can be configured to receive various signals from various satellites through the GPS antenna 124, and to calculate a position of the NFC enabled communication device 100 based on the received signals. The GPS module 106 may be implemented using a Global Navigation Satellite System (GNSS) receiver which can be configured to use the GPS, GLONASS, Galileo and/or Beidou systems for calculating the position of the NFC enabled communication device 100.

The cellular module 108 can be configured to provide wireless communication through the cellular antenna 126 between the NFC enabled communication device 100 and another cellular capable device over a cellular network in accordance with various cellular communication standards such as a Generation Partnership Project (3GPP) Long Term Evolution (LTE) communications standard, a fourth generation (4G) mobile communications standard, or a third generation (3G) mobile communications standard to provide some examples. The cellular module 108 may communicate with one or more transceivers, referred to as base stations or access points, within the cellular network to provide voice and/or data communications between the NFC enabled communication device 100 and another cellular capable device. The transceivers may be connected to a cellular telephone exchange that connects to a public telephone network or to another cellular telephone exchange within the cellular network.

The secure element 110 can be configured to securely store applications and/or information such as payment information, authentication information, ticketing information, and/or marketing information to provide some examples, within the NFC enabled communication device 100, and to provide for an environment for secure execution of these applications. The secure element 110 can be implemented as a separate secure smart card chip, in, among other things, a subscriber identity module (SIM)/Universal Integrated Circuit Card (UICC), or a secure digital (SD) card that can be inserted in the NFC enabled communication device 100.

The host processor 112 can be configured to control overall operation and/or configuration of the NFC enabled communication device 100. The host processor 112 may receive information from, among other things, a user interface such as a touch-screen display, an alphanumeric keypad, a microphone, a mouse, a speaker, and/or from other electrical devices or host devices that are coupled to the NFC enabled communication device 100. The host processor 112 can be configured to provide this information to the NFC module 102, the Bluetooth® module 104, the GPS module 106, the cellular module 108, the secure element 110, the WLAN module 114, and/or the WPT module 116. Additionally, the host processor 112 can be configured to receive information from the NFC module 102, the Bluetooth® module 104, the GPS module 106, the cellular module 108, the secure element 110, the WLAN module 114, and/or the WPT module 116. The host processor 112 may provide this information to the user interface, to other electrical devices or host devices, and/or to the NFC module 102, the Bluetooth® module 104, the GPS module 106, the cellular module 108, the secure element 110, the WLAN module 114, and/or the WPT module 116 via the communication interface 118. Further, the host processor 112 can be configured to execute one or more applications such as SMS for text messaging, electronic mailing, and/or audio and/or video recording to provide some examples, and/or software applications such as a calendar and/or a phone book to provide some examples.

The WLAN module 114 can be configured to provide wireless communications between the NFC enabled communication device 100 and another WLAN capable device over a wired communication network and/or via the WLAN antenna 128 to a wireless communication network in accordance with various networking protocols such a Worldwide Interoperability for Microwave Access (WiMAX) communications standard or a Wi-Fi™ communications standard to provide some examples. The WLAN module 114 can operate as an access point to provide communications between other WLAN capable devices and a communication network, or as a client to communicate with another access point, such as a wireless router to provide an example, to access the communication network.

The WPT module 116 can be configured to provide wireless power transfer between the NFC enabled communication device 100 and another WPT capable device through the WPT antenna 130 in accordance with various WPT standards. The WPT module 102 can be configured to support wireless transmission of power from a wireless power transmitter or another similar electronic device that emits a magnetic field. The WPT module 116 may derive or harvest power from a received WPT signal, such as a magnetic resonance that is provided by the wireless power transmitter. This power that is derived or harvested from the received WPT signal can sometimes be adequate to operate the WPT module 116, the NFC module 102, and/or the secure element 110.

The communication interface 118 can be configured to route various communications between the NFC module 102, the Bluetooth® module 104, the GPS module 106, the cellular module 108, the secure element 110, the host processor 112, the WLAN module 114, and/or the WPT module 116. These communications can include various digital signals, such as one or more commands and/or data to provide some examples, various analog signals, such as direct current (DC) currents and/or voltages to provide some examples, or any combination thereof. The communication interface 118, as well as other communication interfaces that are discussed below, can be implemented as a series of wireless interconnections between the NFC module 102, the Bluetooth® module 104, the GPS module 106, the cellular module 108, the secure element 110, the host processor 112, the WLAN module 114, and/or the WPT module 116. The interconnections of the communication interface 118, as well as interconnections of other communication interfaces that are discussed below, can be arranged to form a parallel architecture interface to carry communications between various modules of the NFC enabled communication device 100 in parallel using multiple conductors, a resonant interface to carry communications between various modules of the NFC enabled communication device 100 using a single conductor, or any combination thereof. An NFC enabled communication device, such as the NFC enabled communication device 100 to provide an example, may include one or more integrated circuits that can be configured and arranged to form one or more modules, such as the NFC module 102, the Bluetooth® module 104, the GPS module 106, the cellular module 108, the secure element 110, the host processor 112, the WLAN module 114, and/or the WPT module 116 to provide some examples.

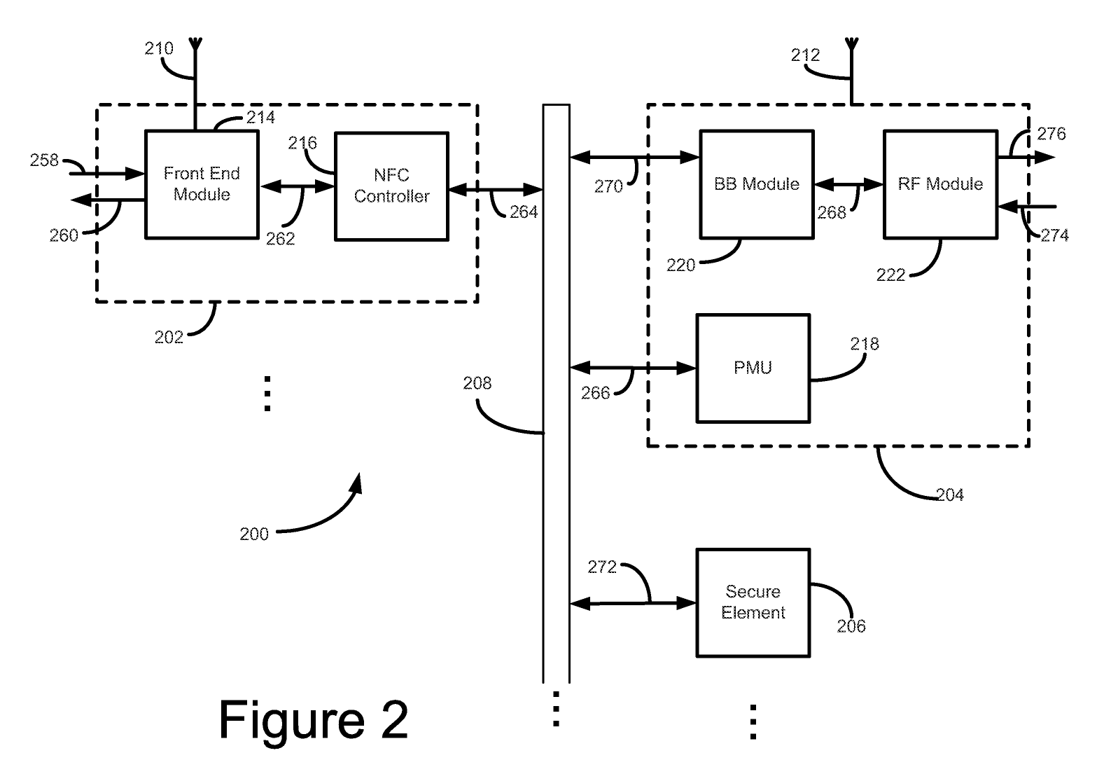

FIG. 2 further illustrates a block diagram of an exemplary NFC enabled communication device according to an exemplary embodiment of the present disclosure. An NFC enabled communication device 200 can include one or more integrated circuits that can be configured and arranged to form one or more modules that are used to communicate information over wireless communication networks in accordance with various communication standards. The NFC enabled communication device 200 may include an NFC module 202, a cellular module 204, and a secure element 206 which can be communicatively coupled to one another via a communication interface 208. An NFC antenna 210 can be connected to the NFC module 202 and a cellular antenna 212 can be connected to the cellular module 204. The NFC enabled communication device 200 can represent another exemplary embodiment of the NFC enabled communication device 100 of FIG. 1. As such, the NFC module 202, the cellular module 204, the secure element 206, and the communication interface 208 can represent an exemplary embodiment of the NFC module 102, the cellular module 108, the secure element 110, and the communication interface 118, respectively. Additionally, the NFC enabled communication device 200 may further include a Bluetooth® module, a GPS module, a host processor, a WLAN module, and/or a WPT module such as the Bluetooth® module 104, the GPS module 106, the host processor 112, the WLAN module 114, and/or the WPT module 116, respectively, of FIG. 1. The Bluetooth® module, the GPS module, the host processor, the WLAN module, and/or WPT module may be communicatively coupled to the NFC module 202, the cellular module 204, and/or the secure element 206 via the communication interface 208.

The NFC module 202 can be configured to provide wireless communications between the NFC enabled communication device 200 and another NFC capable device in accordance with various NFC standards in the reader or in the tag mode of operations in a substantially similar manner as the NFC module 102. In the initiator or reader mode, the NFC module 202 can be configured to actively generate an RF field that provides an NFC communications signal to another NFC capable device and/or power the other NFC capable device if the other NFC capable device is a passive target device. The NFC module 202 can also communicate in a peer-to-peer fashion with another NFC capable device if the other NFC capable device is itself powered. In the tag mode of operation, the NFC enabled communication device 200 can be configured to derive or harvest power from another NFC capable device and to provide the other NFC capable device with tag data. For example, tag data can include personal data, such as debit and/or credit card information, loyalty program data, PINs and/or networking contacts, stored on the secure element 206. Another way to explain the different NFC communications modes are active communication mode and passive communication mode. In active communication mode, both the initiator device and target device communicate alternatively generating their own fields. Generally, one device deactivates its RF field while it is waiting for data, and the other device activates its RF field and couples to the deactivated device through inductive coupling. After receiving the data it needs, the first device may then reactivate its RF field, and the second device may deactivate its RF field and couple itself to the RF field of the first device through inductive coupling. In this mode, both the initiator and target devices typically have their own power supply. In passive communication, the initiator device can provide a carrier field, and the target device can answer by modulating the provided carrier field. In this mode, the target device may draw its operating power from the electromagnetic field generated by the initiator device.

The NFC module 202 can include a front end module (FEM) 214 and/or an NFCC 216. FEM 214 can be configured to provide an interface between the NFC module 202 and another NFC capable device. In one embodiment, the FEM 214 can be configured as an RF front end, such as, for example, an analog high voltage system possibly based on a generally larger gate process, in conjunction with a digital back-end, such as, for example, a low voltage system possibly based on a generally small gate process. When the NFC module 202 is operating in the reader mode of operation, the FEM 214 can be configured to generate a magnetic field, sometimes referred to as a transmitted NFC communication signal 260, which can be modulated by another NFC capable device with information to form an NFC communication signal 258 that may be received by the FEM 214/NFC module 202. The FEM 214 can also modulate the magnetic field with information, such as data and/or one or more commands that are received from a front end module controller (FEM-CTRLR) communication interface 262 to form the transmitted NFC communication signal 260 when the NFC module 202 is operating in the reader mode of operation. Alternatively, when the NFC module 202 is operating in the tag mode of operation, the FEM 214 can be configured to inductively receive an NFC communication signal 258 which may represent a magnetic field generated by another NFC capable device that can be modulated with information. The FEM 214 can also modulate the received NFC communication signal 258 with information, such as data and/or one or more commands, that are received from a FEM-CTRLR communication interface 262 to form the transmitted NFC communication signal 260 when the NFC module 202 is operating in the tag mode of operation. The FEM 214 can be configured to derive or harvest power from the received NFC communication signal 258 and provide the harvested NFC power to the NFC controller 216 via the FEM-CTRLR communication interface 262.

The FEM 214 can be configured to recover and then provide information from the received NFC communication signal 258 to the NFC controller 216 via the FEM-CTRLR communication interface 262 when the NFC module 202 is operating in the reader and tag modes of operation. Specifically, the FEM 214 may convert its own magnetic field when the NFC module 202 is operating in the reader mode of operation, or the magnetic field generated by another NFC capable device when the NFC module 202 is operating in the tag mode of operation, into a voltage and/or a current, and recover the information from the voltage and/or the current.

The NFCC 216 can control overall operation and/or configuration of the NFC module 202. The NFCC 216 can be configured to receive information and/or the harvested NFC power from the FEM 214 via the FEM-CTRLR communication interface 262. Additionally, the NFC controller 216 can route the information and/or the harvested NFC power from the FEM-CTRLR communication interface 262 to a controller communication interface (CTRLR-CI) 264 for routing to the NFC module 202, the cellular module 204, the secure element 206, and/or other modules within the NFC enabled communication device 200 via the communication interface 208. Further, the NFCC 216 can receive information from the NFC module 202, the cellular module 204, the secure element 206, and/or other modules within the NFC enabled communication device 200 via the CTRLR-CI 264. The NFCC 216 can route the information received from the CTRLR-CI 264 to the FEM 214 via the FEM-CTRLR communication interface 262. Further, the NFCC 216 can execute one or more commands provided by the information from the FEM-CTRLR communication interface 262 and/or the CTRLR-CI 264 to control overall operation and/or configuration of the NFC module 202.

The cellular module 204 can be configured to provide wireless communication between the NFC enabled communication device 200 and another cellular capable device over a cellular network in accordance with various cellular communication standards in a substantially similar manner as the cellular module 108. The cellular module 204 can include a power management unit (PMU) 218, a baseband module 220, a radio frequency module 222 and a cellular antenna 212.

The PMU 218 may be configured to take responsibly for battery and power system management of the cellular module 204 and/or the NFC enabled communication device 200. The PMU 218 can be configured to receive various power signals from the NFC module 202, the cellular module 204, the secure element 206, and/or other modules within the NFC enabled communication device 200 from the communication interface 208 via a PMU communication interface (PMU-CI) 266. In one embodiment, the PMU 218 can be configured to monitor the power signals received from the PMU-CI 266 to monitor current, voltages, and/or temperature readings within the NFC enabled communication device 200. Additionally, the PMU 218 can be configured to use the power signals received from the PMU-CI 266 to monitor power connections and battery charges and/or to charge batteries when necessary. Further, the PMU 218 can be configured to use the power signals received from the PMU-CI 266 to control and/or to provide other power signals to the NFC module 202, the secure element 206, and/or other modules within the NFC enabled communication device 200 via the communication interface 208.

The baseband module 220 can be configured to control operation of the cellular module 204. The baseband module 220 may receive information from the RF module 222 via a broadband-radio frequency module (BB-RFM) communication interface 268. Additionally, the baseband module 220 can be configured to provide the information from the BB-RFM communication interface 268 to a baseband communication interface (BB-CI) 270 for routing to the NFC module 202, the secure element 206, and/or other modules within the NFC enabled communication device 200 via the communication interface 208. Further, the baseband module 220 can be configured to receive information from the NFC module 202, the secure element 206, and/or other modules within the NFC enabled communication device 200 from the communications interface 208 via the BB-CI 270. The baseband module 220 can route the information received from the BB-CI 270 to the RF module 222 via the BB-RFM communication interface 268. Further, the baseband module 220 can be configured to execute one or more commands provided by the information from the BB-RFM communication interface 268 and/or the BB-CI 270 to control overall operation and/or configuration of the cellular module 204.

The RF module 222 can be configured to downconvert, demodulate, and/or decode a received cellular communication signal 274 to provide information to the baseband module 220 via the BB-RFM communication interface 268. The RF module 222 can convert the received cellular communication signal 274 from an analog representation to a digital representation. The RF module 222 can also be configured to upconvert, modulate, and/or encode information received from the baseband module 220 via the BB-RFM communication interface 268 to provide a transmitted cellular communication signal 276. The RF module 222 can also convert the information received from the BB-RFM communication interface 268 from a digital representation to an analog representation.

The secure element 206 can be configured to securely store applications and/or information within the NFC enabled communication device 200 and provide for an environment for secure execution of these applications in a substantially similar manner as the secure element 110. The secure element 206 can also be configured to receive the applications and/or the information from the NFC module 202, the cellular module 204, and/or other modules within the NFC enabled communication device 200 from the communication interface 208 via a Secure Element communications interface (SE-CI) 272. The secure element 206 can provide the information and/or other information generated by the applications to the SE-CI 272 for routing onto the NFC module 202, the cellular module 204, and/or other modules within the NFC enabled communication device 200 via the communication interface 208.

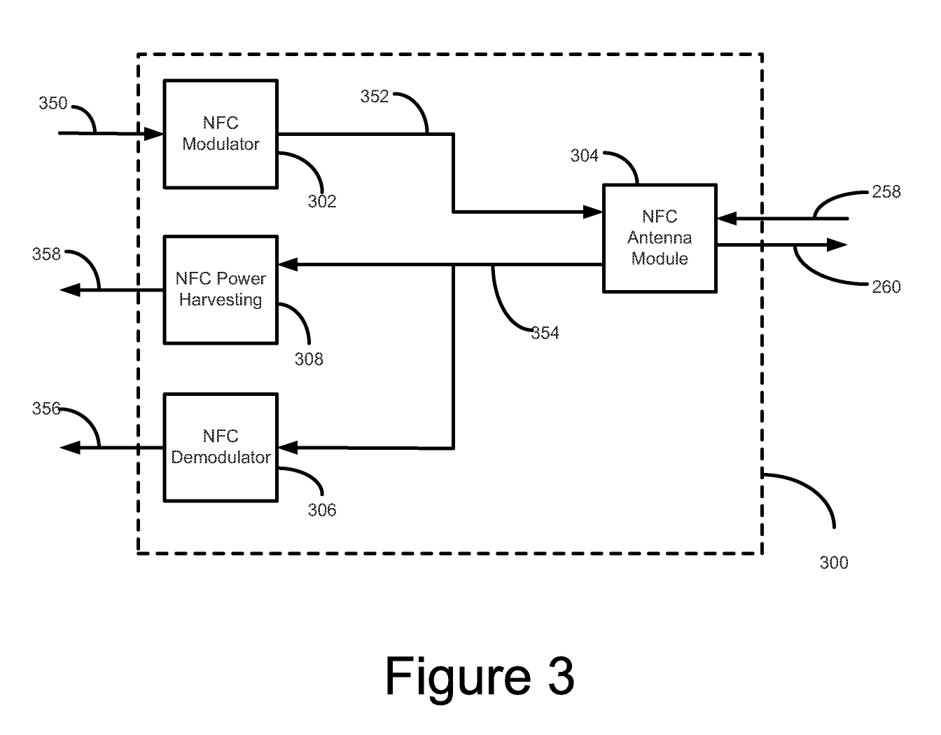

FIG. 3 illustrates one exemplary FEM 300 that can be implemented within an exemplary NFC enabled communication device according to exemplary embodiments of the present disclosure. The FEM 300 can be configured to provide an interface between an NFC enabled communication device, such as the NFC enabled communication device 100 or the NFC enabled communication device 200 to provide some examples, and an NFC capable device. The FEM 300 can be configured to inductively receive various signals from the NFC capable device and recover information and various power signals from these various signals. The FEM 300 can include an NFC modulator module 302, an NFC antenna module 304, an NFC demodulator module 306, and an NFC power harvesting module 308. The FEM 300 can also represent an exemplary embodiment of the FEM 214.

The NFC modulator module 302 can be configured to modulate transmission information 350 onto a carrier wave, such as an RF carrier wave using any suitable analog or digital modulation technique to provide a modulated information signal 352 when the NFC enabled communication device is operating in the reader mode of operation. One commonly used carrier wave frequency for NFC applications is 13.56 MHz, however, other frequencies can be used without departing from the spirit and scope of the present disclosure. Suitable analog or digital modulation techniques may include, among others, amplitude modulation (AM), frequency modulation (FM), phase modulation (PM), phase shift keying (PSK), frequency shift keying (FSK), amplitude shift keying (ASK), quadrature amplitude modulation (QAM) and/or any other suitable modulation technique that will be apparent to those skilled in the relevant art(s). The transmission information 350 can be received from other modules of the NFC enabled communication device over a communication interface, such as the FEM-CTRLR communication interface 262 to provide an example. In some situations, the NFC modulator module 302 can simply provide the carrier wave as the modulated information signal 352. Additionally, the NFC modulator module 302 can be configured to modulate the transmission information 350 using the suitable analog or digital modulation technique to provide the modulated information signal 352 when the NFC enabled communication device is operating in the tag mode of operation.

The NFC antenna module 304 can be configured to inductively receive the NFC communication signal 258 from another NFC capable device to provide a recovered NFC communication signal 354. Additionally, the NFC antenna module 304 can be configured to provide the transmitted NFC communication signal 260 based upon the modulated information signal 352. As mentioned above and described in greater detail below, the NFC antenna module 304 can include multiple inductive coupling elements, controlled by a switch and driven by an NFCC. The multiple inductive coupling elements could be placed in different locations within the NFC enabled device to increase the operating volume and provide extended field coverage for the NFC enabled device. When the NFC enabled communication device is operating in the reader mode of operation, the NFC antenna module 304 can apply the modulated information signal 352 to one or more of the multiple inductive coupling elements to generate a magnetic field that represents the transmitted NFC communication signal 260. Alternatively, the NFC antenna module 304 can apply the modulated information signal 352 to one or more of the multiple inductive coupling elements of the antenna module 304 to modulate a magnetic field from another NFC capable device that is inductively coupled to one or more of the multiple inductive coupling elements of the antenna module 304 with the modulated information signal 352 to provide the transmitted NFC communication signal 260.

The NFC demodulator module 306 can be configured to demodulate the recovered NFC communication signal 354 to extract a recovered information signal 356 that was modulated using any suitable analog or digital modulation technique. The suitable analog or digital modulation technique may include, among others, AM, FM, PM, PSK, FSK, ASK, QAM and/or any other suitable modulation technique that will be apparent to those skilled in the relevant art(s). The recovered information signal 356 can be provided to other modules of the NFC enabled communication device over a communication interface, such as the FEM-CTRLR communication interface 262 to provide an example.

The NFC power harvesting module 308 can be configured to derive or harvest power from the recovered NFC communication signal 354 to provide a harvested NFC power 358. In an exemplary embodiment, the NFC power harvesting module 308 can include a rectifier to rectify the recovered NFC communication signal 354 to provide rectified NFC power. In one exemplary embodiment, the NFC power harvesting module 308 can additionally include a regulator to regulate the rectified NFC power to provide the harvested NFC power 358. In some situations, the harvested NFC power 358 can be provided to other modules of the NFC enabled communication device over a communication interface, such as the FEM-CTRLR communication interface 262 to provide an example.

NFC communications work generally on the principle of resonant inductive coupling. Resonant inductive coupling is the near field wireless transmission of electrical energy between two coils that are tuned to resonate at the same or very similar frequency. In practice, an NFC enabled device can act as an NFC transmitter by applying an oscillating current to a coil to create an oscillating magnetic field. Another NFC capable device having a coil resonating at the same or similar frequency as the oscillating magnetic field that is placed in the oscillating magnetic field near the NFC transmitter can couple with the NFC transmitter, thereby picking up energy and/or information from the oscillating magnetic field.

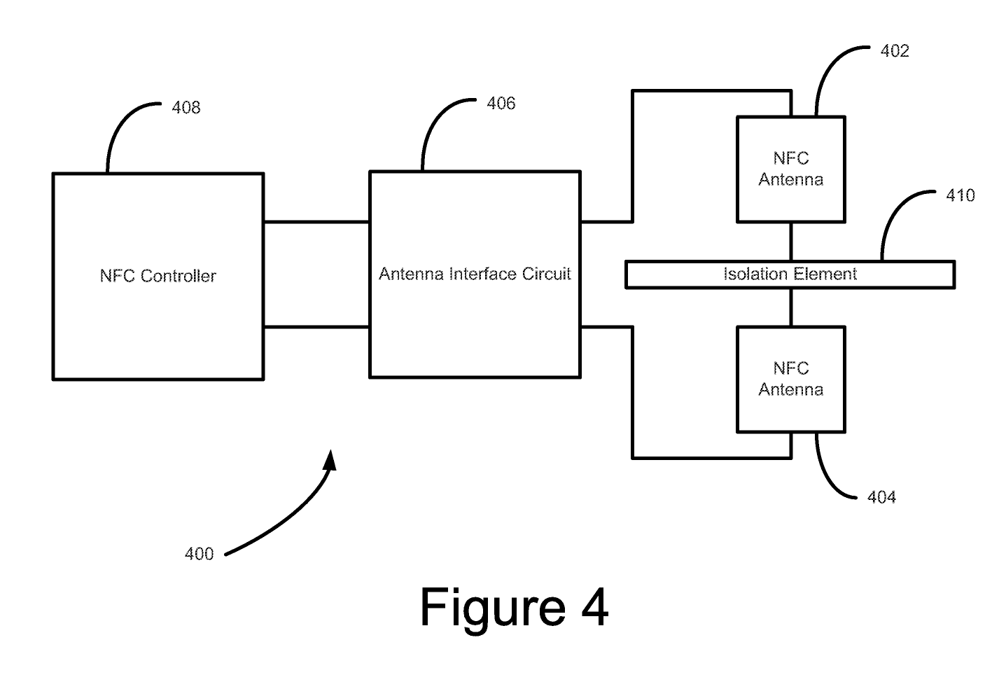

FIG. 4 illustrates an exemplary multiple antenna arrangement 400 for implementing NFC in accordance with various embodiments of the present disclosure. The multiple antenna arrangement can be implemented within an exemplary NFC enabled communication device (such as NFC enabled communication devices 100 and/or 200) according to exemplary embodiments of the present disclosure. The multiple antenna arrangement 400 for implementing NFC in accordance with various embodiments of the present disclosure can be made up of a first antenna 402 that is connected in series with a second antenna 404, an antenna interface circuit 406, an NFCC 408 (such as NFCC 216), and an isolation element 410 (e.g., a printed circuit board (PCB) material upon which one or more of the aforementioned elements can be implemented/configured upon and a ferrite material) The first and second antennas 402 and 404, as well as the antenna interface circuit 406 can present, e.g., 8 Ohms (equivalent) at 13.56 MHz and 200 mA pk, at the NFCC 408 pins.

It should be noted that the first antenna 402 can be positioned in one location within the NFC enabled communication device, such as a tablet computer (e.g. NFC enabled communication devices 100 and/or 200), such as proximate to the front side of the NFC enabled communication device, and the second antenna 404 can be positioned in another location within the NFC enabled communication device, such as proximate to the back side of the NFC enabled communication device. The utilization of multiple antennas as contemplated herein is made possible because NFC fields are typically very small. Moreover, various embodiments of the present disclosure, such as the exemplary multiple antenna arrangement illustrated in FIG. 4, can utilize an isolation element, such as isolation element 410, to magnetically isolate first antenna 402 from second antenna 404, while other embodiments may utilize magnetically coupled antennas, as will be described in detail below.

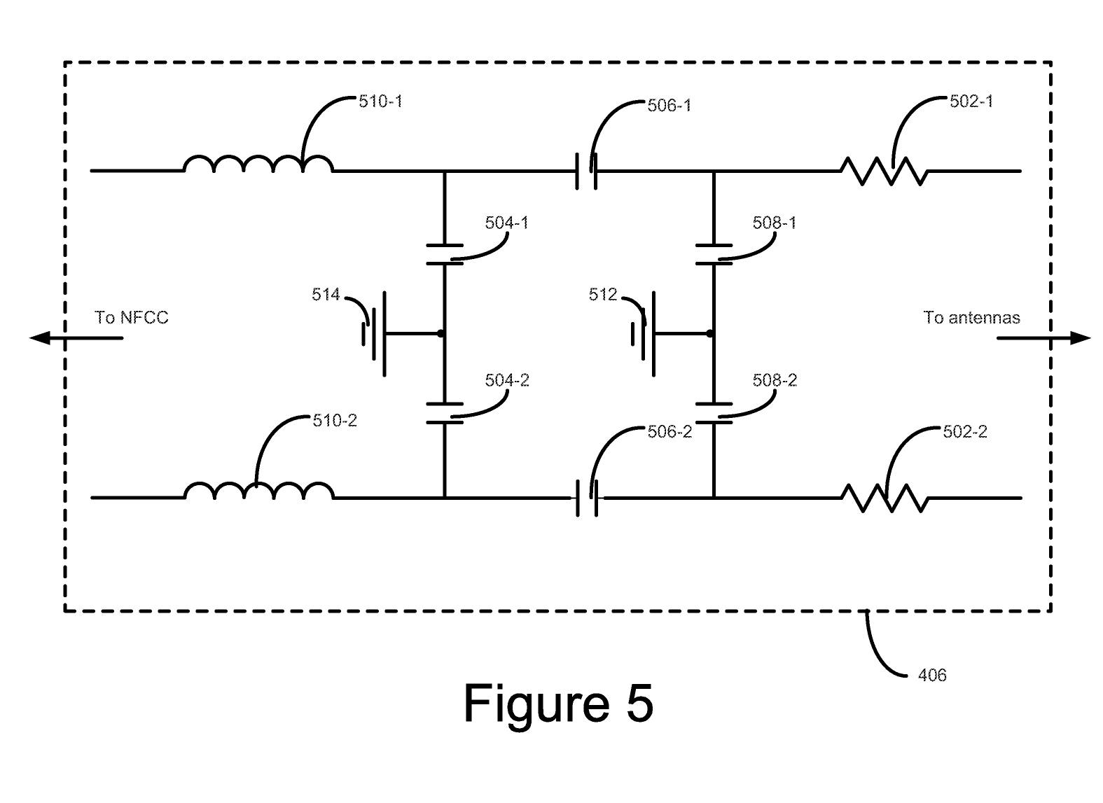

FIG. 5 illustrates an exemplary equivalent circuit for implementing antenna interface circuit 406, which can allow for interaction between antennas (e.g., first antenna 402 and second antenna 404) and an NFCC (e.g., NFCC 408), such that the NFCC can control operation of antennas. Moreover, the antenna interface circuit 406 may further be considered an embodiment of FEM 214, wherein the antenna interface circuit 406 can effectuate NFC communications, e.g., by coupling transmitter and receiver portions of the NFC enabled communication device, via the NFCC 408, to the first and second antennas 402 and 404, and/or acting as an RF front end. Accordingly, antenna interface circuit 406 can include first and second resistors 502 (i.e. 502-1 and 502-2), which may be zero Ohm surface mount resistors, a first set of capacitors 504 (i.e. 504-1 and 504-2), which may be 180 pF, a second set of capacitors 506 (i.e. 506-1 and 506-2), which may be 39 pF, and a third set of capacitors 508 (i.e. 508-1 and 508-2). Antenna interface circuit 406 may further include a set of inductors 510 (i.e. 510-1 and 510-2), as well as grounds 512 and 514. It should be noted that the various values/settings of the aforementioned elements for the above embodiment (as well as those described below) can vary according to desired operating characteristics/conditions.

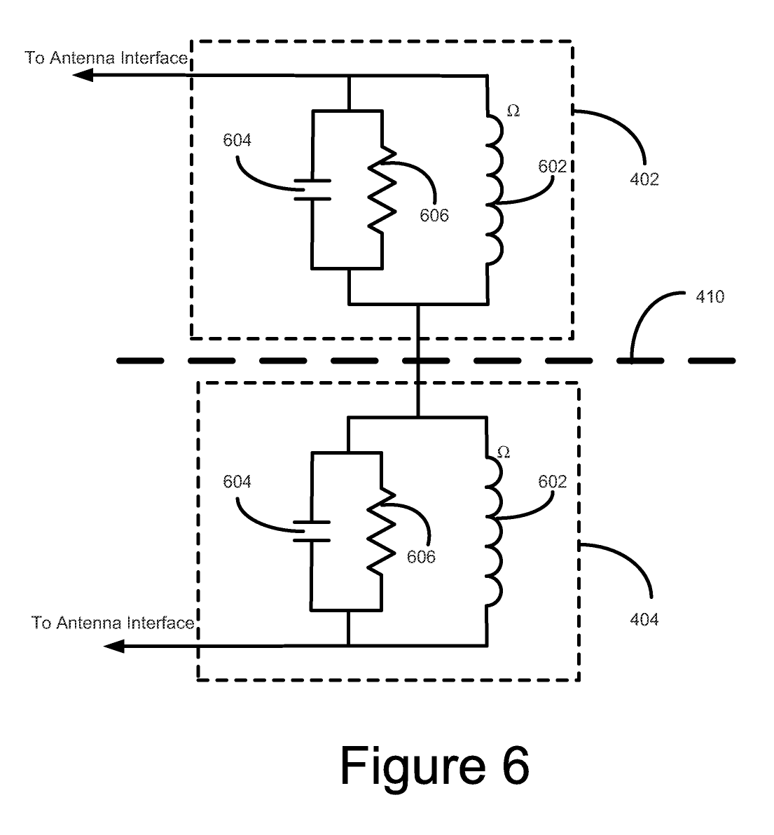

FIG. 6 illustrates an exemplary equivalent circuit for implementing first and second antennas 402 and 404. It should be noted that for ease of description, like elements described in each of the first and second antennas 402 and 404 will be referenced with the same reference numerals. That is, first and second antennas 402 and 404 can include an inductive coupling element 602. Additionally, first and second antennas 402 and 404 can include a parallel resistor-capacitor element (made up of a capacitor 604 and a resistor 606) for tuning the inductive coupling element 602 to resonate at a frequency suitable for implementing NFC communications, where in one embodiment, as alluded to previously, the frequency may be 13.56 MHz. The capacitor 604 may be a 6.678 pF capacitor, the resistor 606 may be a 20.14 kOhm resistor, and the inductive coupling element 602 (which can be an inductor/coil) may be a 2065 nH inductor with a resistance of 0.9958 Ohms.

In particular, the first and second antennas can be electric quadrupole (E2) 4 turn antennas, connected in series via, and each of the first and second antennas 402 and 404 can be have a piece of ferrite centered on the inductive element/coil. The first and second antennas, as alluded to above, can be located can be located on either side of a tablet computer (effectively, either side of a PCB within the tablet computer) that is, e.g., 10″ from corner-to-corner. The first and second antennas 402 and 404, as well, can have varying dimensions, e.g., first antenna 402 can be a 9 mm×50 mm antenna, and second antenna can be a 30 mm×50 mm antenna. It should be noted that the various values/settings/configurations of the aforementioned elements for the above embodiment (as well as those described below) can vary according to desired operating characteristics/conditions.

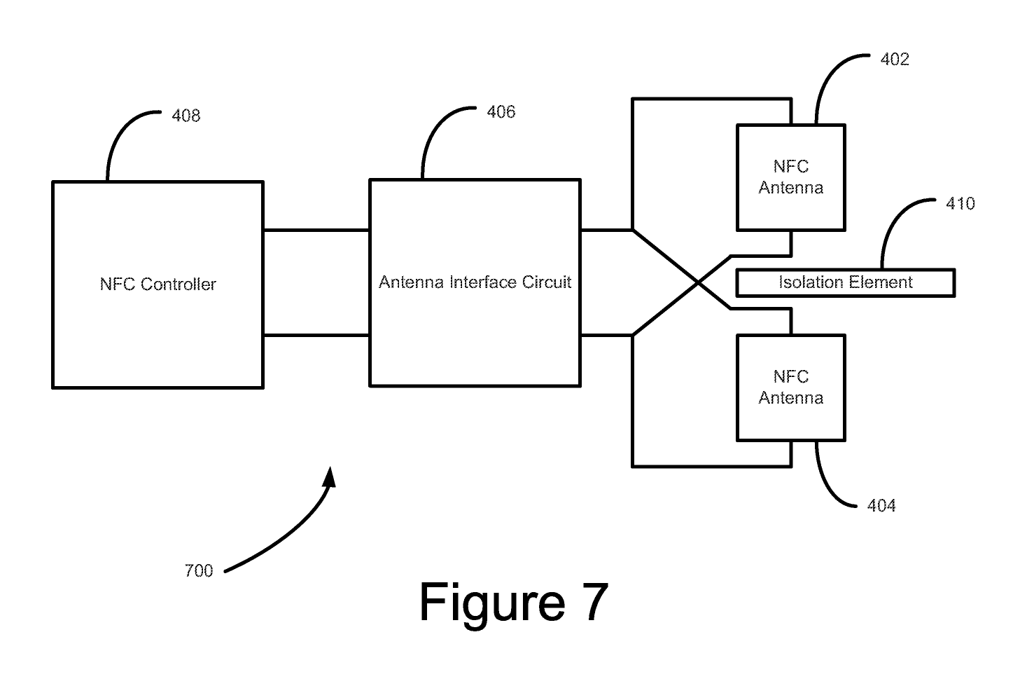

FIG. 7 illustrates an exemplary multiple antenna arrangement 700 for implementing NFC in accordance with another embodiment of the present disclosure. Like the multiple antenna arrangement 400, the multiple antenna arrangement 700 can be implemented within an exemplary NFC enabled communication device (such as NFC enabled communication devices 100 and/or 200) according to exemplary embodiments of the present disclosure. Also like the multiple antenna arrangement 400, the multiple antenna arrangement 700 can include a first antenna 402 and a second antenna 404, an antenna interface circuit 406, an NFCC 408 (such as NFCC 216), and an isolation element 410 (e.g., a printed circuit board (PCB) material upon which one or more of the aforementioned elements can be implemented/configured upon and a ferrite material). In this embodiment, however, the first and second antennas 402 and 404 can be connected in parallel, rather than in series. Moreover, the first and second antennas 402 and 404, as well as the antenna interface circuit 406 can present, e.g., 8 Ohms (equivalent) at 13.56 MHz and 200 mA pk, at the NFCC 408 pins. Further still, it should be noted that when the first and second antennas 402 and 404 are coupled in parallel as illustrated in FIG. 7, the signal strength is divided between the first and second antennas (in particular, the inductive elements/coils), and the first and second antennas 402 and 404 may require similar/the same configurations in order to balance load. As previously described with reference to FIG. 6, first and second antennas 402 and 404 can include an inductive coupling element and a parallel resistor-capacitor element (made up of a capacitor and a resistor) for tuning the inductive coupling element to resonate at a frequency suitable for implementing NFC communications.

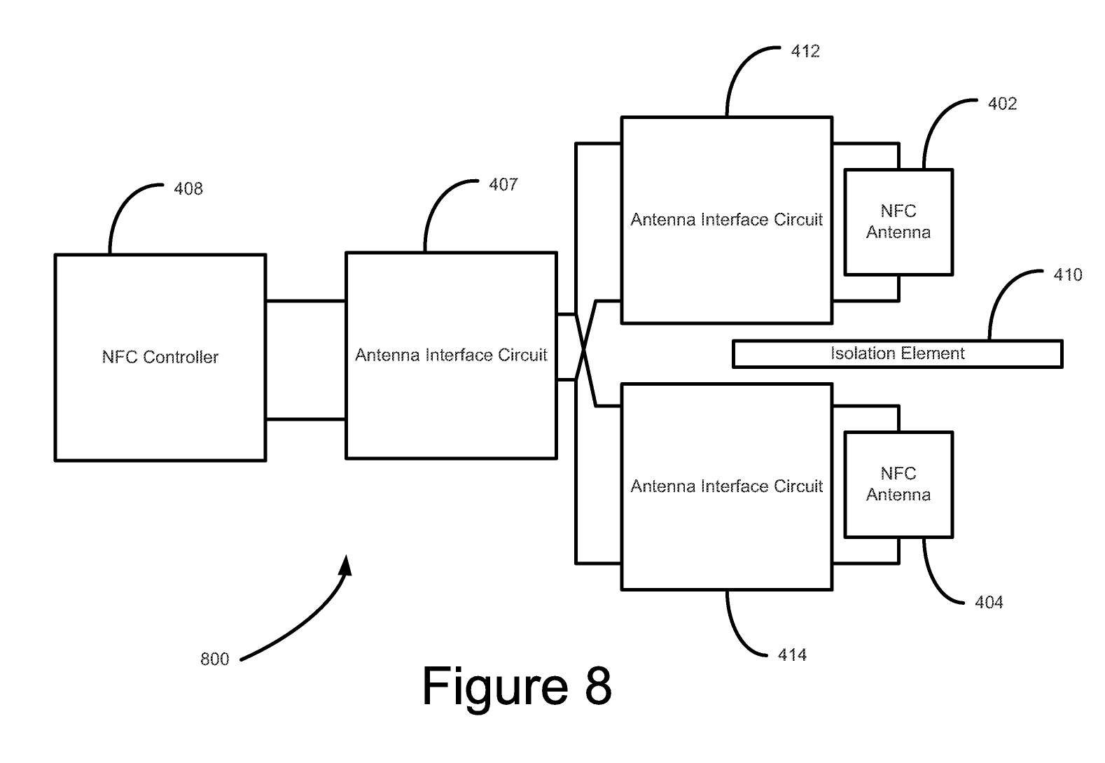

FIG. 8 illustrates an exemplary multiple antenna arrangement 800 for implementing NFC in accordance with still another embodiment of the present disclosure. Like the multiple antenna arrangement 400, the multiple antenna arrangement 800 can be implemented within an exemplary NFC enabled communication device (such as NFC enabled communication devices 100 and/or 200) according to exemplary embodiments of the present disclosure. The multiple antenna arrangement 800 can include a first antenna 402 and a second antenna 404, three antenna interface circuits 407, 412, and 414, an NFCC 408 (such as NFCC 216), and an isolation element 410 (e.g., a printed circuit board (PCB) material upon which one or more of the aforementioned elements can be implemented/configured upon and a ferrite material). In this embodiment, like the multiple antenna arrangement 700, the first and second antennas 402 and 404 can be connected in parallel, rather than in series. However, additional antenna interface circuits 412 and 414 can be implemented. That is, antenna interface circuit 407 can include a first pair of inductors, similar to the equivalent circuit described in FIG. 5 (e.g., 510-1 and 510-2), but may only have a pair of capacitors (e.g., 504-1 and 504-2). Antenna interface circuits 412 and 414 may each include four capacitors (e.g., 506-1, 506-2, 508-1, and 508-2) and, like the equivalent circuit described in FIG. 5, two resistors (e.g., 502-1 and 502-2). Again, the first and second antennas 402 and 404, as well as the antenna interface circuit 407 can present, e.g., 8 Ohms (equivalent) at 13.56 MHz and 200 mA pk, at the NFCC 408 pins. Also and again, the signal strength is divided between the first and second antennas (in particular, the inductive elements/coils), and the first and second antennas 402 and 404 may require similar/the same configurations in order to balance load. As previously described with reference to FIG. 6, first and second antennas 402 and 404 can each include an inductive coupling element and a parallel resistor-capacitor element (made up of a capacitor and a resistor) for tuning the inductive coupling element to resonate at a frequency suitable for implementing NFC communications.

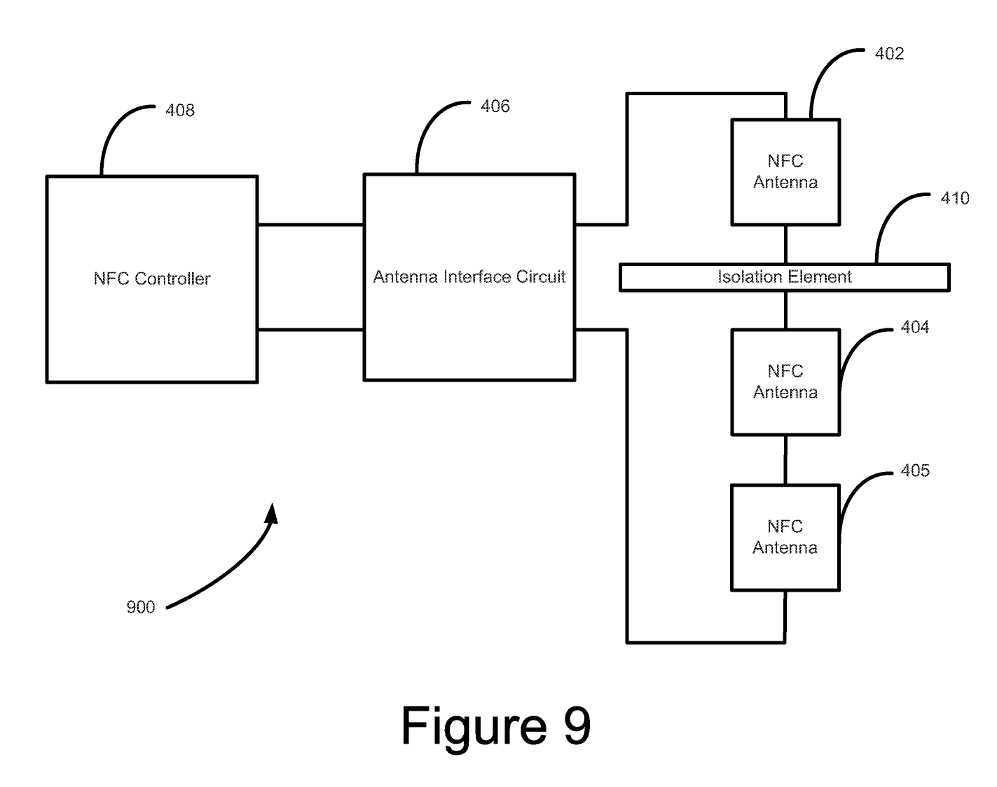

FIG. 9 illustrates an exemplary multiple antenna arrangement 900 for implementing NFC in accordance with yet another embodiment of the present disclosure. Again, and similar to the previously described and illustrated embodiments, the multiple antenna arrangement 900 can be implemented within an exemplary NFC enabled communication device (such as NFC enabled communication devices 100 and/or 200) according to exemplary embodiments of the present disclosure. The multiple antenna arrangement 900 can include a first antenna 402, a second antenna 404, and a third antenna 405, along with an antenna interface circuit 406, an NFCC 408 (such as NFCC 216), and an isolation element 410 (e.g., a printed circuit board (PCB) material upon which one or more of the aforementioned elements can be implemented/configured upon and a ferrite material). In this embodiment, the first and second antennas 402 and 404 can be connected in series, and can be magnetically isolated. The third antenna 405 can be connected in series to the second antenna 404 without any isolation element therebetween (i.e. magnetically coupled). The antenna interface circuit 406, similar to the antenna interface circuit of FIG. 4 can include a first pair of inductors, similar to the equivalent circuit described in FIG. 5 (e.g., 510-1 and 510-2), six capacitors (e.g., 504-1, 504-2, 506-1, 506-2, 508-1, and 508-2), and two resistors (e.g., 502-1 and 502-2). The first, second, and third antennas 402, 404, and 405, as well as the antenna interface circuit 406 can present, e.g., 8 Ohms (equivalent) at 13.56 MHz and 200 mA pk, at the NFCC 408 pins. As previously described with reference to FIG. 6, first, second, and third antennas 402, 404, and 405 can each include an inductive coupling element and a parallel resistor-capacitor element (made up of a capacitor and a resistor) for tuning the inductive coupling element to resonate at a frequency suitable for implementing NFC communications.

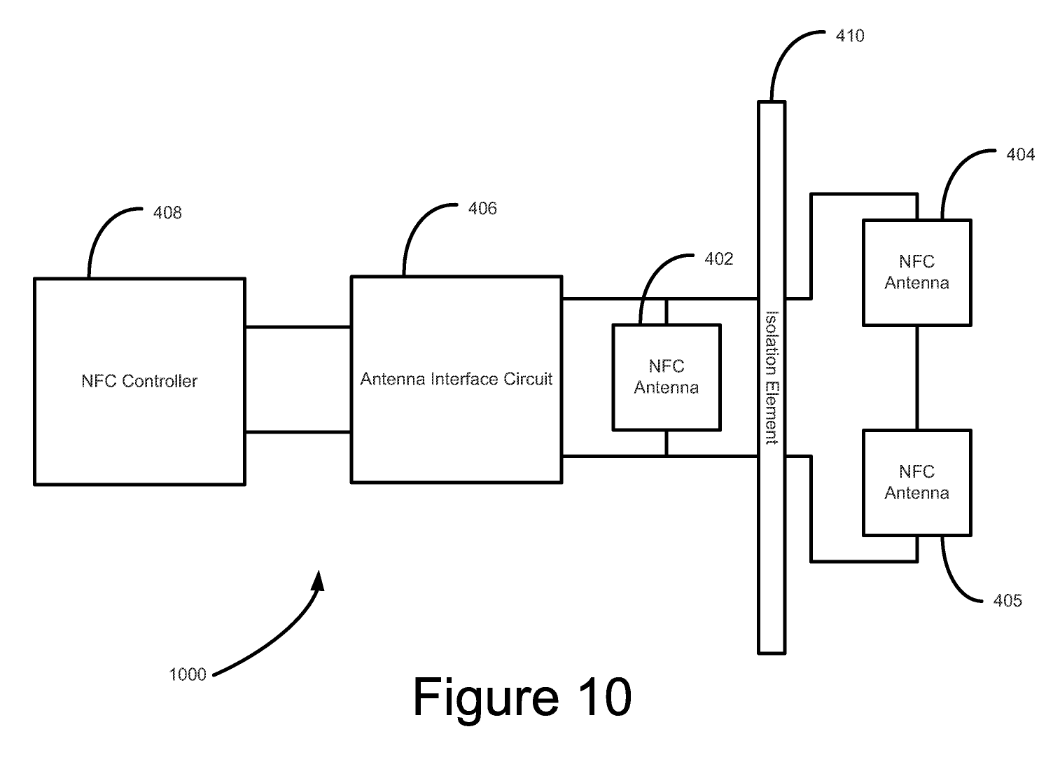

FIG. 10 illustrates an exemplary multiple antenna arrangement 1000 for implementing NFC in accordance with yet another embodiment of the present disclosure. Again, and similar to the previously described and illustrated embodiments, the multiple antenna arrangement 1000 can be implemented within an exemplary NFC enabled communication device (such as NFC enabled communication devices 100 and/or 200) according to exemplary embodiments of the present disclosure. The multiple antenna arrangement 100 can include a first antenna 402, a second antenna 404, and a third antenna 405, along with an antenna interface circuit 406, an NFCC 408 (such as NFCC 216), and an isolation element 410 (e.g., a printed circuit board (PCB) material upon which one or more of the aforementioned elements can be implemented/configured upon and a ferrite material). In this embodiment, the second and third antennas 404 and 405 can be connected in series, and can be magnetically coupled. The first antenna 402 can be connected in parallel to the second and third antennas 404 and 405 with the isolation element 410 between the first antenna 402 and both the second and third antennas 404 and 405. The antenna interface circuit 406, similar to the antenna interface circuit of FIG. 4 can include a first pair of inductors, similar to the equivalent circuit described in FIG. 5 (e.g., 510-1 and 510-2, each 300 nH), six capacitors (e.g., 504-1 and 504-2, each 180 pF, 506-1 and 506-2, each 68 pF, and 508-1 and 508-2, each 68 pF), and two resistors (e.g., 502-1 and 502-2, each 1 Ohm). The first, second, and third antennas 402, 404, and 405, as well as the antenna interface circuit 406 can present, e.g., 8 Ohms (equivalent) at 13.56 MHz and 200 mA pk, at the NFCC 408 pins. As previously described with reference to FIG. 6, first, second, and third antennas 402, 404, and 405 can each include an inductive coupling element (2060 nH with 1.3 Ohm resistance for first and second antennas 402 and 404, and 2065 nH with 0.9958 Ohm resistance for third antenna 405), and a parallel resistor-capacitor element (where each capacitor is 3.367 pF and each resistor is 13.61 kOhm for the first and second antennas 402 and 404, and the capacitor is 6.678 pF and the resistor is 20.14 kOhm for the third antenna 405) for tuning the inductive coupling element to resonate at a frequency suitable for implementing NFC communications. It should be noted that additional inductive elements (not shown) can be incorporated between the first and second antennas 402 and 404 (e.g., a 110 nH coil), and between the first and third antennas 402 and 405, and between the second and third antennas 404 and 405, each 60 nH.

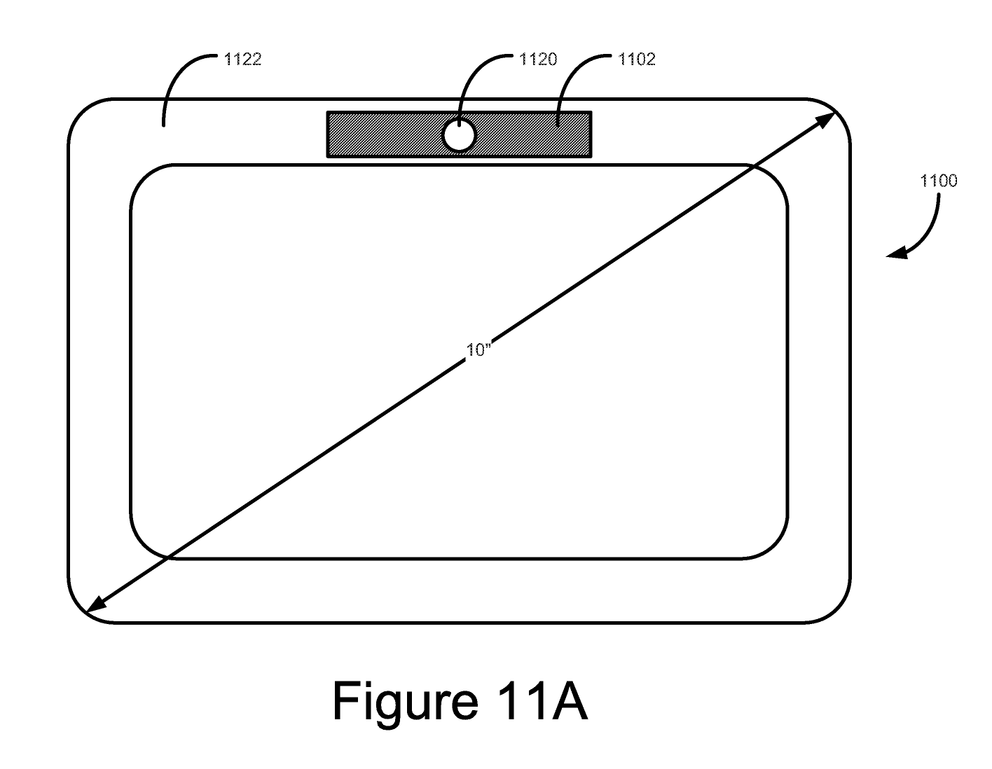

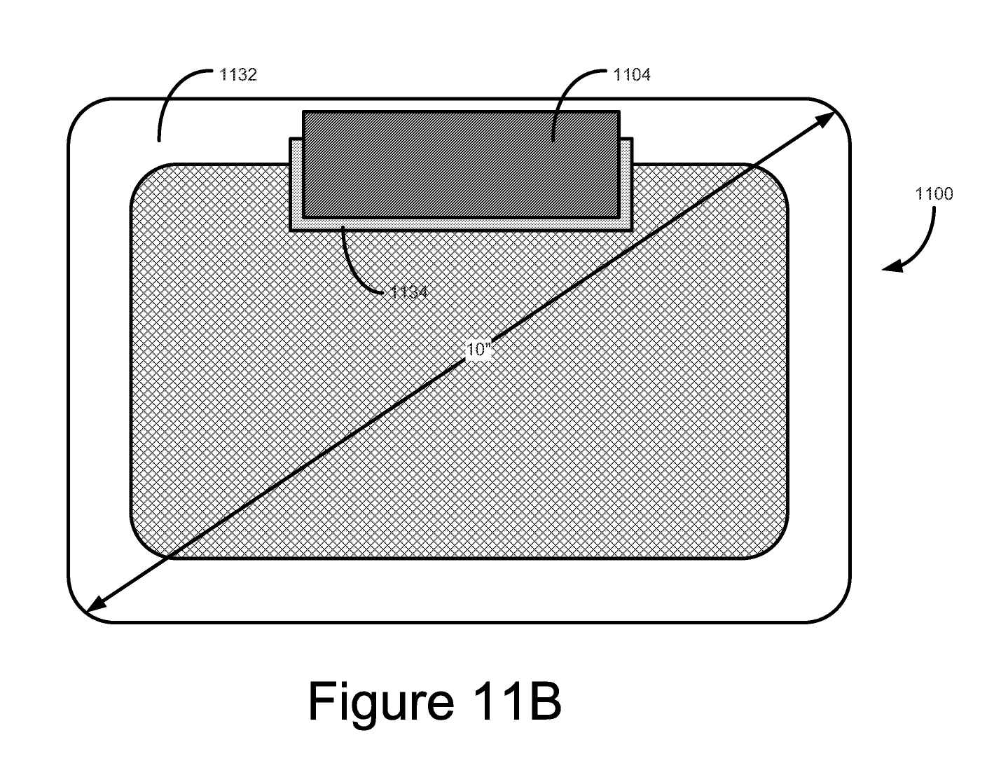

FIGS. 11A and 11B illustrate front and rear views of an exemplary NFC enabled communication device 1100, which may be a tablet computer, in which the multiple antenna arrangements described herein may be implemented for providing NFC communications. As alluded to previously, the NFC enabled communication device 1100 may be 10 inches from corner-to-corner. FIG. 11A illustrates the frontal view of NFC enabled communication device 1100, which may include a first antenna 1102 (with the dimensions 9 mm×50 mm) located at a frontal area of the NFC enabled communication device 1100. The NFC enabled communication device 1100 may further include a camera 1120, and region 1122 may be a non-ferrite region. FIG. 11B illustrates a rear view of NFC enabled communication device 1100, and can include a second antenna 1104 (with the dimensions 30 mm×50 mm), a non-ferrite region 1132, and a ferrite region 1134.

Again, various configurations and dimensions of a multiple antenna arrangement are contemplated in accordance with various embodiments of the present disclosure. As another example, first and second antennas, respectively located on frontal and rear areas of an NFC enabled communication device can have the same dimensions, e.g., 50 mm×30 mm.

It should be noted that the present disclosure include various diagrams that may depict an example architectural or other configuration for the various embodiments, which is done to aid in understanding the features and functionality that can be included in embodiments. The present disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement various embodiments. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and/or functionality described in one or more of the individual embodiments are not limited in their applicability to the particular embodiment with which they are described, but instead can be applied, alone or in various combinations, to one or more of the other embodiments, whether or not such embodiments are described and whether or not such features, aspects and/or functionality are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the terms “example” or “exemplary” are used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in, e.g., a non-transitory computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

As used herein, the term module can describe a given unit of functionality that can be performed in accordance with one or more embodiments. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. Where components or modules of the various embodiments are implemented in whole or in part using software, in one embodiment, these software elements can be implemented to operate with a computing or processing module capable of carrying out the functionality described with respect thereto. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An antenna arrangement for facilitating near field communication (NFC) in an NFC enabled communication device, comprising:
at least two antennas connected either in series or in parallel;
at least one antenna interface circuit;
an NFC controller operably connected to the at least one antenna interface and configured to control operation of the at least two antennas; and
an isolation element adapted to magnetically isolate the at least two antennas from each other.

2. The antenna arrangement of claim 1, wherein the each of the at least two antennas comprises a parallel resistor capacitor element connected in parallel with an inductive element.

3. The antenna arrangement of claim 1, wherein the at least one antenna interface circuit comprises a set of two resistors, a set of two inductors, and three sets of capacitors, each of the three sets of capacitors comprising two capacitors.

4. The antenna arrangement of claim 3, wherein each resistor of the set of two resistors have equal resistance.

5. The antenna arrangement of claim 3, wherein each inductor of the set of two inductors have equal inductance.

6. The antenna arrangement of claim 3, wherein each capacitor of each of the three sets of capacitors have equal capacitance.

7. The antenna arrangement of claim 1, wherein the at least one antenna interface circuit comprises a first antenna interface circuit connected in parallel with a first of the at least two antennas, a second antenna interface circuit connected in parallel with a second of the at least two antennas, and a third antenna interface circuit operably connected between each of the first and second antenna interface circuits and the NFC controller.

8. The antenna arrangement of claim 4, wherein the first antenna interface circuit comprises a first set of four capacitors and a first set of two resistors.

9. The antenna arrangement of claim 4, wherein the second antenna interface circuit comprises a second set of four capacitors and a second set of two resistors.

10. The antenna arrangement of claim 4, wherein the third antenna interface circuit comprises a set of two inductors and a third set of two capacitors.

11. The antenna arrangement of claim 1, wherein the at least two antennas and the at least one antenna interface circuit present substantially 8 Ohms at 13.56 MHz at pins of the NFC controller.

12. The antenna arrangement of claim 1, wherein the at least two antennas comprise a first antenna connected in series to a second antenna, and a third antenna connected in series to the second antenna, wherein the first antenna and the second antenna are magnetically isolated by the isolation element.

13. The antenna arrangement of claim 1, wherein the at least two antennas comprise a first antenna connected in parallel to a second antenna and a third antenna, wherein the second antenna and the third antenna are connected in series, and wherein the first antenna is magnetically isolated from each of the second antenna and the third antenna.

14. The antenna arrangement of claim 1, wherein a first antenna of the at least two antennas is implemented on a frontal region of the NFC enabled communication device, and wherein the second antenna of the at least two antennas is implemented on a rear region of the NFC enabled communication device, the NFC enabled communication device comprising a tablet computer.

15. A device, comprising:
a first near field communication (NFC) antenna located in a frontal region of the device;
a second NFC antenna located in a rear region of the device, the first and second NFC antennas being connected in series, and being magnetically isolated by an isolation element;
an antenna interface circuit; and
an NFC controller adapted to, with the antenna interface circuit, control and drive the first and second NFC antennas to effectuate NFC communications.

16. The device of claim 15 further comprising, a third NFC antenna connected in series to the second NFC antenna, and between the second NFC antenna and the antenna interface circuit.

17. The device of claim 16, wherein the second NFC antenna and the third NFC antenna are magnetically coupled.

18. A device, comprising:
a first near field communication (NFC) antenna located in a frontal region of the device;
a second NFC antenna located in a rear region of the device, the first and second NFC antennas being connected in parallel, and being magnetically isolated by an isolation element;
an antenna interface circuit; and
an NFC controller adapted to, with the antenna interface circuit, control and drive the first and second NFC antennas to effectuate NFC communications.

19. The device of claim 18 further comprising, a second antenna interface circuit and a third antenna interface circuit, the second antenna interface circuit being connected in parallel with the first NFC antenna, and the third antenna interface circuit being connected in parallel with the second NFC antenna.

20. The device of claim 18 further comprising, a third NFC antenna connected in series with and magnetically coupled with the second NFC antenna, such that the first NFC antenna, in addition to be connected in parallel with the second NFC antenna, is further connected in parallel with the third NFC antenna, and is further magnetically isolated from the third NFC antenna by the isolation element.
